(19) United States
(12) Patent Application Publication
(10) Pub. No.: US 2025/0387972 A1
(43) Pub. Date: Dec. 25, 2025

(54) ADDITIVE MANUFACTURING OF ARCHITECTURED MORPHING STRUCTURES

(71) Applicant: UT-Battelle, LLC, Oak Ridge, TN (US)

(72) Inventors: Steven J. Guzorek, Knoxville, TN (US); Julian L. Charron, Knoxville, TN (US); Ryan C. Ogle, Knoxville, TN (US); Thomas Feldhausen, Knoxville, TN (US); Ahmed A. Hassen, Knoxville, TN (US); Brian K. Post, Knoxville, TN (US)

(21) Appl. No.: 19/249,162

(22) Filed: Jun. 25, 2025

Related U.S. Application Data
(60) Provisional application No. 63/663,738, filed on Jun. 25, 2024.
(60) Provisional application No. 63/774,185, filed on Mar. 19, 2025.

(51) Int. Cl. B29C 64/30; B29C 64/386; B33Y 10/00; B33Y 40/20; B33Y 50/00

(52) U.S. Cl. CPC B29C 64/30; B29C 64/386; B33Y 10/00; B33Y 40/20; B33Y 50/00

(57) ABSTRACT

A method of forming an additively manufactured part includes: converting a desired final three-dimensional part geometry into a flattened, computer-modeled shape; operating a printhead to deposit a first layer of a part-forming material on a substrate, the first layer being one of a plurality of iteratively deposited layers of an additive build according to the flattened, computer-modeled shape, such that the additive build is comprised of successive layers of the deposited part material on the substrate; and creating a part by manipulating one or more portions of the additive build at one or more predetermined locations to form the additive build into a final shape having the desired final three-dimensional part geometry. The part-forming material and the substrate each may include a thermoset or thermoplastic, and may include a curable resin. The substrate may be in the form of an impregnated or unimpregnated sheet, film, fabric, laminated fabric, or weave.

### CROSS-REFERENCE TO RELATED APPLICATIONS

This application claims the benefit of U.S. Provisional Application No. 63/663,738 filed Jun. 25, 2024, and U.S. Provisional Application No. 63/774,185 filed Mar. 19, 2025, the disclosures of which are incorporated by reference in their entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to additive manufacturing, and more particularly to methods to form composite three-dimensional objects via additive manufacturing.

### BACKGROUND OF THE INVENTION

Generating large composite structures presents many manufacturing complications, one of which is making large molds can be difficult and can require significant time and cost expenditures. The development of large-scale additive manufacturing (AM) has had a significant impact on the thought processes behind how parts are formed. However, large-scale additive manufacturing still has challenges. For example, in order to generate part geometries utilizing additive manufacturing, conventional additive manufacturing processes generally require the formation of a large number of very small layers (relative to total size) that add up to the final geometry. Additive manufacturing machines can generally deposit material very rapidly intra-layer (i.e., within each specific layer), but adding up all of the required layers for the desired part is a significant speed limiting factor for building large-scale components by additive manufacturing. Thus, very long print times, on the order of days, can be required to additively manufacture large and/or thin-walled parts such as, for example, a wind generator blade, an airplane wing, or a boat. Further, certain part geometries are not as easily formed by additive manufacturing. These part geometries may be alternatively formed by, for example, open molding processes (e.g., vacuum molding, chop and spray molding, layup molding), but molding processes have the drawback that a mold must first be designed, created, and utilized to mold the part.

Given this backdrop, a continuing need exists for advanced, improved additive manufacturing processes that allow for forming structures such as large-scale composite parts faster and/or at a lower cost.

### SUMMARY OF THE INVENTION

An improved method of forming an additively manufactured part is provided. In various embodiments, the method includes the step of converting a desired final three-dimensional part geometry into a flattened, computer-modeled shape. The method further includes the step of operating a printhead to deposit a first layer of a part-forming material on a substrate. The first layer is one of a plurality of iteratively deposited layers of an additive build according to the flattened, computer-modeled shape, such that the additive build is comprised of successive layers of the deposited part material on the substrate. The method further includes the step of creating a part by manipulating one or more portions of the additive build at one or more predetermined locations to form the additive build into a final shape having the desired final three-dimensional part geometry, and fixing the additive build into the final shape.

In specific embodiments, the step of manipulating the additive build includes one or both of bending and folding the additive build at the one or more predetermined locations.

In particular embodiments, the bending is performed along fold lines formed in the additive build.

In certain embodiments, the method further includes the step of bonding or adhering adjacent portions of the additive build along the bent fold lines.

In specific embodiments, the additive build includes a geometric locking element, and the method further includes the step of interlocking the geometric locking element when manipulating the additive build in order to constrain the additive build in the final shape.

In particular embodiments, the method further includes the step of curing the additive build after manipulating the additive build.

In specific embodiments, the additive build includes one or more fold lines, and each fold line includes one or both of: i) tapered edges; and (ii) gaps between deposited part-forming material on the substrate.

In specific embodiments, the additive build includes an articulated structure.

In specific embodiments, the computer-modeled shape includes a planar lattice structure.

In specific embodiments, the substrate is one of: i) a preformed material; and ii) formed by operating a printhead to deposit one or more layers of a substrate-forming material on a build surface.

In specific embodiments, the substrate is also formed according to the flattened, computer-modeled shape.

In specific embodiments, the substrate is flexible or includes both flexible and rigid portions.

In specific embodiments, the substrate: i) is removed after manipulation of the additive build; ii) is integrated into the part created by manipulating the additive build; or iii) becomes the final part by removal of the additive build.

In specific embodiments, the substrate includes: i) a fabric; ii) a film; iii) a sheet; iv) a fabric laminated with a film; or v) a weave.

In specific embodiments, the part-forming material is either: i) bondable to the substrate; ii) a curable material; or iii) both i) and ii).

In specific embodiments, the part-forming material includes one or more of: i) a thermoplastic; ii) a thermoset; and iii) a plurality of different materials.

In specific embodiments, the method further includes the step of operating a printhead to deposit a first layer of a scaffold material on the substrate or the additive build. The first layer is one of a plurality of iteratively deposited layers of a scaffold additive build according to a three-dimensional computer model of a scaffold, such that the scaffold additive build is comprised of successive layers of the deposited scaffold material that form the scaffold.

In particular embodiments, the step of creating the part includes joining portions of the scaffold together.

In particular embodiments, at least a portion of the scaffold is integrated into the part created by manipulating the additive build.

In specific embodiments, the step of creating the part includes curing targeted portions of the additive build.

In particular embodiments, the curing is performed by: i) application of an external stimulus; or ii) forming the targeted portions of the additive build with a plurality of part-forming materials having different cure rates.

In specific embodiments, the part-forming material is a curable material, and the method further includes the steps of: partially curing the deposited part-forming material that forms the additive build; while the part-forming material is only partially cured, manipulating the one or more portions of the additive build at the one or more predetermined locations in order to form the additive build into the final shape; and subsequent to manipulating the additive build and while maintaining the additive build in the final shape, completing the curing of the part-forming material.

An additively manufactured part formed by the method according to any of the preceding embodiments is also provided.

These and other features of the invention will be more fully understood and appreciated by reference to the description of the embodiments and the drawings.

### BRIEF DESCRIPTION OF THE DRAWINGS

FIG. 1 is a schematic illustration of a method of forming an additively manufactured part in accordance with embodiments of the disclosure;

FIG. 2 is a perspective view of an unfolded additive build in accordance with specific embodiments of the disclosure;

FIG. 3 is a plan view of the unfolded additive build of FIG. 2;

FIG. 4 is a side view of the unfolded additive build of FIG. 2;

FIG. 5 is a side view of the additive build of FIG. 2 manipulated into a folded configuration to form the additive build into a final shape having a desired final three-dimensional part geometry;

FIG. 6 is a perspective view of the additive build of FIG. 5 formed into the final shape;

FIG. 7 is a perspective view of an unfolded additive build in accordance with other specific embodiments of the disclosure;

FIG. 8 is a plan view of the unfolded additive build of FIG. 7;

FIG. 9 is a side view of the unfolded additive build of FIG. 7;

FIG. 10 is a side view of the additive build of FIG. 7 manipulated into a folded configuration to form the additive build into a final shape having a desired final three-dimensional part geometry; and

FIG. 11 is a perspective view of the additive build of FIG. 10 formed into the final shape.

### DETAILED DESCRIPTION OF THE CURRENT EMBODIMENTS

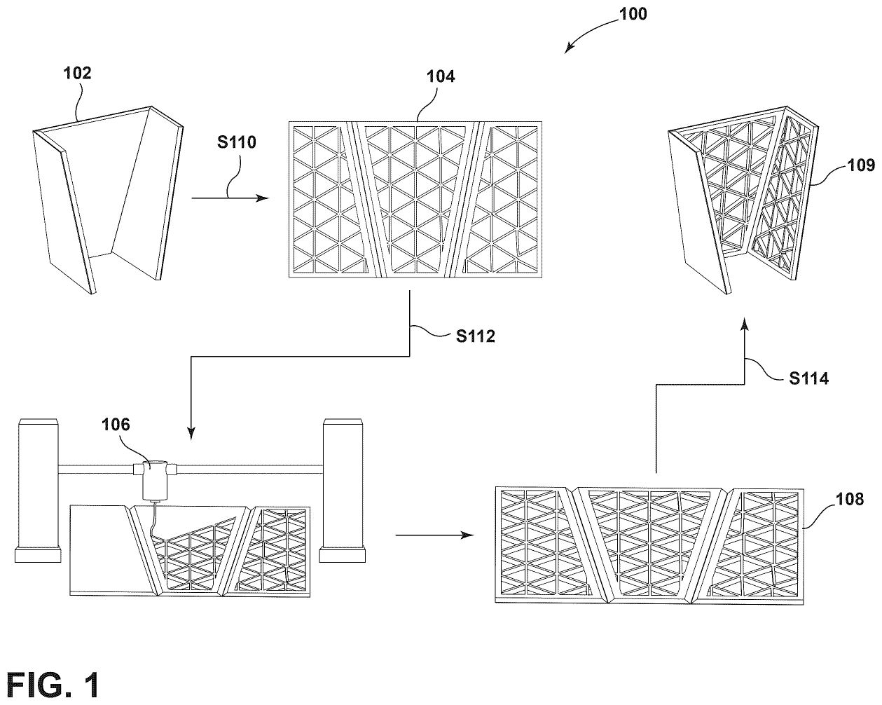

As discussed herein, the current embodiments relate to improved methods of forming additively manufactured parts, including but not limited to large-scale composite parts, that provide for the creation of parts at build rates that are significantly faster than for conventional additive manufacturing processes. The current embodiments also relate to additively manufactured parts formed by the improved methods. The improved methods can be used with existing build materials, thereby not requiring the development of new material feedstocks, and can be used to form composite structures having a variety of geometric complexities more quickly, more easily, and/or at a lower cost than with conventional processes. In some embodiments, the method may provide approximately a two-thirds or more reduction in build time in comparison to conventional direct additive manufacturing methods. As generally illustrated schematically in FIG. 1, the method 100 includes converting a three-dimensional part geometry into a flattened shape, printing the flattened shape as an additive build, and manipulating the additive build into a final shape having the desired three-dimensional part geometry. Each step is separately discussed below.

At step S110, the method 100 first includes converting a desired final three-dimensional part geometry 102 into a flattened, computer-modeled shape 104. This step S110 thus may include a selection of a three-dimensional part for formation by additive manufacturing. Once the part is selected, the part may be analyzed, either manually or with the assistance of computer-based software, to determine one or more ways to obtain the three-dimensional (3D) part from a generally flat, planar shape by bending, folding, warping, and the like. Determining the flattened shape is akin to unfolding a paper airplane from its folded shape to a flat, planar sheet of paper. Analogously, flattening the 3D shape may include “unfolding” the part design into a flat projection of the final shape (e.g., a Mercator projection), or in other words, converting a 3D shape or complex surface into a flat representation in which surface area is conserved (e.g., using an organizer). Determining the flattened shape is also akin to unfolding and/or flattening a shape that is made by origami/kirigami. As such, the flattened shape may be two-dimensional (2D), but it also may have features giving it a degree of height such that the flattened shape is a 2.5D shape having a length and width that is much greater than its height, and such that the height of the flattened shape is less than, optionally significantly less than, the height of the desired 3D object. As discussed in more detail below, example features that may give the flattened shape a small degree of height include scaffolding, a lattice structure, angled joints, and interlocking connectors. When the generally flat, planar shape is determined, a computer model of the flat, planar shape is generated. The generated computer-modeled shape is one that is capable of being formed as an additive build (e.g., by 3D printing the model layer-by-layer) and that may be sliced into a plurality of layers that may each be formed by depositing build material. In some embodiments, the computer-modeled shape may include a planar or planar-like lattice structure that forms a skeleton (e.g., an internal frame that supports and strengthens) for the final part, while the substrate acts as a skin (e.g., external layer) for the final part. As such, the substrate may be integrated into the final part. The skeleton formed of the part-forming material therefore may be a discontinuous and/or may have a plurality of void spaces, while the substrate skin may be a continuous structure (e.g., sheet, film) or nearly continuous (e.g., fabric or weave having some porosity).

After converting the desired final three-dimensional part geometry into a flattened, computer-modeled shape 104, the method 100 next includes, at step S112, operating a printhead 106 to deposit a first layer of a part-forming build material on a substrate. The printhead is generally a printhead that is used for or is capable of being used for additive manufacturing (i.e., 3D printing), wherein the printhead and/or a build surface are operable to move in three dimensions relative to each other, and the printhead is operable to deposit part-forming material iteratively layer-by-layer to form an additive build 108 according to the flattened, computer-modeled shape 104. The additive build 108 therefore includes successive layers of the deposited material on the substrate. The additive build may include one or a plurality of fold lines that divide adjacent portions of the additive build. The fold lines may be formed of, for example, adjacent tapered edges along opposing edges of a skeleton-like structure defined by the additive build formed of deposited part-forming material. The fold lines may also include gaps between the two opposing, tapered edges of the skeleton-like structure, wherein the gap is defined by the substrate material between the two opposing, tapered edges. The tapered edges and/or gaps thereby may define an articulated joint structure of the additive build. The angle of the taper and the distance between the gap determined a degree of bending between the two adjacent portions of the additive build, such that the additive build may be articulated as described in more detail below.

The substrate may be a preformed material that is obtained prior to performing the method. For example, the substrate may be a fabric, a weave, or a sheet that is made separate from the method and placed on the build surface prior to operating the printhead to deposit part-forming material. Alternatively, the substrate may be formed in situ on the build surface by operating a printhead to deposit one or more layers of a substrate-forming material on the build surface. In these embodiments, the substrate may be a single deposited layer such as a sheet or film, or may be formed as an additive build by iteratively depositing successive layers of a substrate material(s) on a build surface. As such, the substrate layer(s) may be included in the flattened, computer-modeled shape of the part, and the substrate may then be formed according to the computer-modeled shape. The substrate layer(s) may also be included in the flattened, computer-modeled shape even if the substrate is not deposited by the printhead and is instead place on the build surface prior to deposition of the part-forming material by the printhead onto the substrate. The printhead used to form the substrate in these embodiments may be the same printhead or a different printhead than the printhead used to deposit the part-forming material. The substrate may also be a hybrid material such as a fabric including a laminated film layer thereon.

The substrate may be flexible (compliant, elastomeric) or may include both flexible portions and rigid portions. In yet other embodiments, the substrate may be rigid. It should also be understood that the substrate may be flexible until it is cured and hardened into a final desired configuration, at which time it may no longer be flexible. The substrate may be formed of a thermoplastic or thermoset. Exemplary thermoplastic materials for the substrate include but are not limited to thermoplastic polyurethane (TPU; flexible), carbon fiber-acrylonitrile butadiene styrene (CF-ABS; rigid), CF-ABS with TPU portions (rigid-elastomeric hybrid having compliant portions), glass (silicon) filled TPU (rigid), and polyethylene terephthalate glycol (PETG). Exemplary fabric materials for the substrate include but are not limited to Nylon or Nylon with a TPU-laminated film (fabric with laminate hybrid). Exemplary weaves for the substrate include but are not limited to a fiberglass weave. Exemplary thermoset materials for the substrate include but are not limited to latent cure, ambient cure, and UV cure resin systems such as urethanes and epoxys (i.e., resins that cure by application of a stimulus such as heat or UV radiation or that cure by passage of a certain amount of time), and also may include a sheet (e.g., urethane), a film (e.g., a prepreg epoxy film such as carbon fiber or fiberglass pre-impregnated with epoxy), an uninfused fabric, or a prepreg fabric. The substrate material also may optionally include a metallic material such as a metal powder.

In various embodiments, the part-forming material is a thermoplastic or thermoset resin. The part-forming material may be chosen based on the desired mechanical properties of the final part, compatibility with the substrate material, and/or the manner in which the additive build is to be manipulated into the final part geometry. Exemplary thermoplastic materials for the part-forming material include but are not limited to acrylonitrile butadiene styrene (ABS; rigid), carbon fiber-acrylonitrile butadiene styrene (CF-ABS; rigid), and a higher heat deflection temperature (HDT) material such as a polycarbonate (PC). Exemplary thermoset materials for the part-forming material include but are not limited to latent cure, ambient cure, and UV cure resin systems such as urethanes and epoxys (rigid structures), and also may include other rigid polymers. The part-forming material also may optionally include a metallic material such as a metal powder.

Exemplary combinations of substrate materials and part-forming materials include but are not limited to TPU (compliant/elastomeric substrate skin) and ABS (rigid part-forming structure), CF-ABS having TPU portions (rigid/elastomeric hybrid substrate skin) and CF-ABS (rigid part-forming structure), glass-filled TPU (rigid substrate skin) and PC (rigid part-forming structure having higher HDT than the substrate skin), Nylon having TPU laminate (flexible fabric/laminate hybrid substrate skin) and CF-ABS (rigid part-forming structure), flexible urethane (compliant/elastomeric substrate skin) and rigid urethane (rigid part-forming structure), prepreg epoxy film (B-staged rigid skin) and rigid epoxy (rigid part-forming structure), thin film thermoplastic or thermoset (substrate skin) and rigid epoxy (rigid part-forming structure), uninfused fabric (substrate skin) and rigid urethane or epoxy (rigid part-forming structure), and prepreg fabric (substrate skin) and rigid urethane or epoxy (rigid part-forming structure). The part-forming material may be bondable to the substrate, either upon cooling or upon curing or both, or alternatively the part-forming material may not bond to the substrate so that the part-forming material may be later removed from the substrate or vice versa.

In certain embodiments, the method further includes operating a printhead to deposit a first layer and subsequent layers of a scaffold material on the substrate or the additive build. The layers of scaffold material are a plurality of iteratively deposited layers of a scaffold additive build according to a three-dimensional computer model of a scaffold, such that the scaffold additive build is comprised of successive layers of the deposited scaffold material that form the scaffold. The scaffold becomes an internal portion of the final part, and is useful in holding the final part in a desired configuration. Thus, at least a portion of the scaffold may be integrated into the final part created by manipulating the part as described below, such as by joining portions of the scaffold together, for example by locking elements. Alternatively, the scaffold may merely support the additive build in a desired configuration until final curing of the additive build as described below.

After forming the additive build 108, the method 100 next includes, at step S114 creating a part by manipulating one or more portions of the additive build 108 at one or more predetermined locations to form the additive build into a final shape 109 having the desired final three-dimensional part geometry, and then fixing the additive build into the final shape. For example, the manipulation of the additive build may include bending the additive build along fold lines formed in additive build such as the tapered edges and/or gaps as described above. After bending along a fold line, the tapered edges may be adhered together with a suitable adhesive or otherwise chemically bonded together, in order to hold the adjacent portions of the additive build in the desired spatial configuration. The manipulation of the additive build may also or alternatively include folding the additive build at a predetermined location, such as by folding one portion of the additive build over another portion, and then curing, connecting, and/or bonding the folded portions to maintain the portions of the additive build in the desired spatial configuration. For example, targeted portions of the additive build may be cured to create the final part shape, or targeted portions of the additive build may have different cure rates. In other examples, manipulation of the additive build may include bending the additive build into a desired final shape, followed by fully curing substrate and/or the part-forming material to fix the additive build into the desired final shape. Thus, additionally or in the alternative, after manipulating the additive build into the desired configuration, the additive build, for example the substrate of the additive build, may be cured by application of an external stimulus such as UV radiation or heat or by waiting for the passage of a cure time to fix the additive build in the final shape.

In some embodiments, the additive build is designed and formed to include one or more geometric locking elements, such as interlocking clips or other interlocking structures. In these embodiments, when the additive build is manipulated to configure the additive build to the desired final shape, the interlocking clips come together and mate to position and/or lock and hold the additive build in the desired configuration of the final shape.

While the substrate may be integrated into the part created by manipulating the additive build, such as when the substrate forms a skin of the final part and/or when the substrate is cured to fix the additive build into the final part configuration, the substrate alternatively may be removed after manipulation of the additive build. In these embodiments, the final part is formed by the part-forming material but not the substrate material. In yet other alternative embodiments, the substrate itself may become the final part by dissolving and washing away the part-forming material after manipulating the additive build and curing of the substrate material.

In certain embodiments, either the part-forming material, the substrate material, or both is/are a curable material, and the method includes partially curing the part-forming material deposited on the substrate that forms the additive build (and/or partially curing the substrate). The deposited part-forming material may be partially cured only in a range of from 20 to 80% of complete curing of the part-forming material (and likewise in the case of partially curing the substrate). The partial curing is dictated by the cure kinetics of the curable material, such as the cure rate of the material, or by the amount/duration of stimulus (UV, heat) required to cure the material. The curable material is only cured to a gel stage so that it can maintain a degree of shape while ensuring the cure is at a low enough percentage to allow for cross-linking between contacting portions after manipulation into the final part shape. While the part-forming material is only partially cured, one or more portions of the additive build is manipulated at the one or more predetermined locations in order to form the additive build into the final shape. A viscosity of the part-forming material during the step of bending the substrate to manipulate the additive build into the final shape may be in a range of from 0.1 kPa to 300 kPa to allow for manipulation of the part-forming material while at the same time to maintain a degree of fixed rigidity so the part-forming material does not flow out of the desired final shape prior to full curing. Subsequent to manipulating the additive build and while maintaining the additive build in the final shape, the curing of the part-forming material (and/or the substrate) is completed to fully cure the final part in the desired geometry. Thus, in these embodiments, the cure rate(s) of the materials are utilized to only partially cure the deposited material to a state between its original liquid state and a fixed, fully cured state, manipulation of the deposited material during partial cure, followed by final curing while holding the deposited material in the desired final part configuration to obtain the final part having the final part geometry.

Optionally, in these partial cure embodiments, the method may further include depositing a scaffold material to form a scaffold structure, either on the substrate prior to deposition of the part forming material, or onto the part-forming material after formation of the additive build with the part-forming material. The scaffold also may be a curable material, and either may be cully cured prior to deposition of the part-forming material, or only partially cured, such as in a range of 20 to 80% of full cure. The scaffold material may be incorporated into the final part, and for example, if the scaffold material is only partially cured, after manipulation of the additive build, portions of the scaffold material may contact each other and then may be fully cured to bond these portions of scaffold material together to aid in the holding of the additive build in the final part geometry.

### EXAMPLES

The present method is further described in connection with the following examples, which are merely illustrative of embodiments of the method and are intended to be non-limiting.

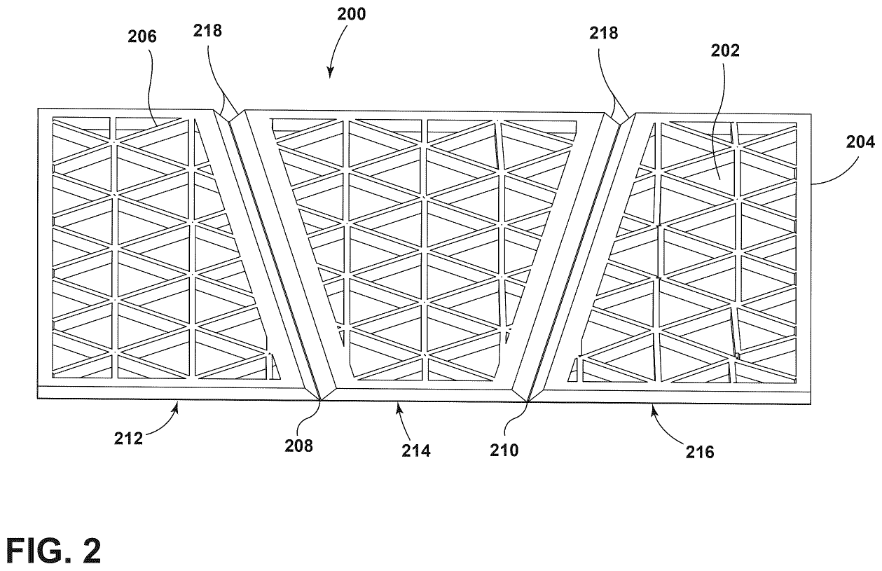

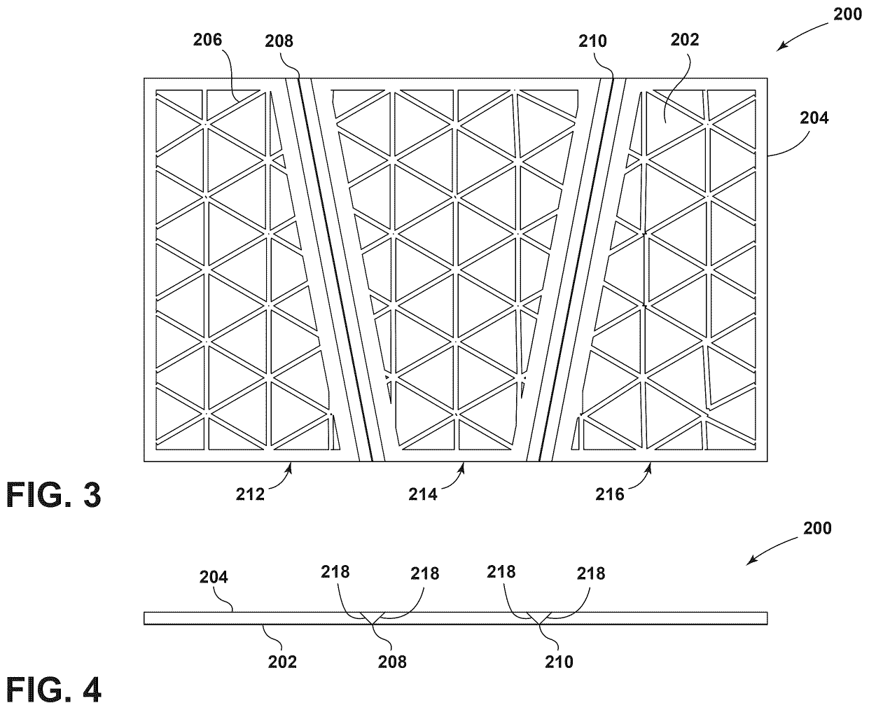

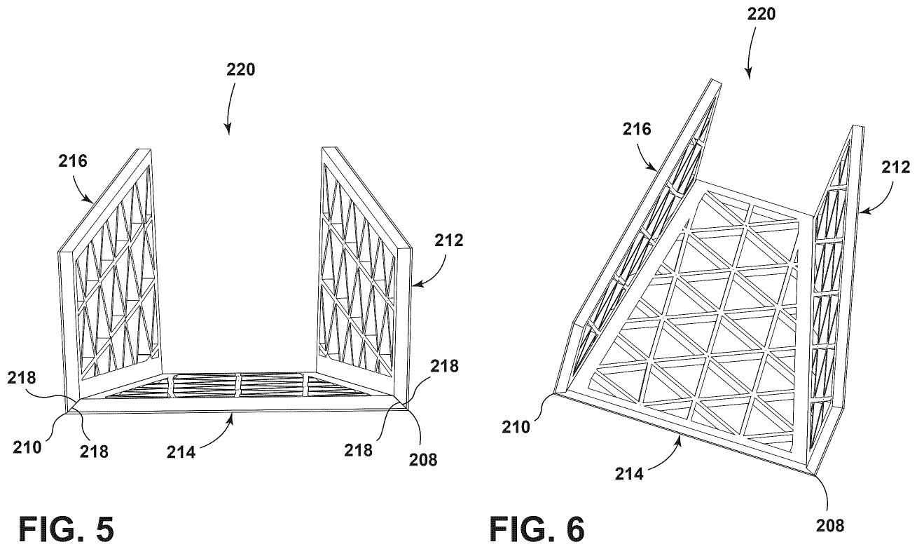

With reference to FIGS. 2-6, in Example 1 a desired part geometry is obtained by bending/articulating an additive build along fold lines, and fixing the additive build in the final shape having the desired part geometry by adhering the bent fold lines. As shown in FIGS. 2-4, the additive build 200 is printed as an unfolded, flattened shape and includes a substrate 202 and part-forming material 204. The substrate 202 is a fabric, sheet, or film that forms a flexible skin of the additive build 200. The part-forming material 204 is additively built into a lattice-like skeleton structure 206, and has fold lines 208, 210 between adjacent portions 212, 214 and adjacent portions 214, 216. The edges of each of the portions 212, 214, 216 include tapers 218 such that the edges are tapered at angles that are determined based on the desired degree of bending between the adjacent portions 214, 216, 218 when the additive build is manipulated into a desired final shape. As shown in FIGS. 5 and 6, upon manipulation the portion 212 is bent relative to portion 214 along the fold line 210. Likewise, portion 216 is bent relative to portion 214 along the fold line 211. An adhesive or other bonding material is placed along the fold lines 210, 211 and tapers 218 prior to or after bending to fix the portions 212, 214, 216 in the folded configuration, thereby creating the desired final shape 220 from the flat additive build 200. It should be understood that the final shape 220 is merely illustrative, and a multitude of different shapes may be created in the same manner according to the method shown in Example 1.

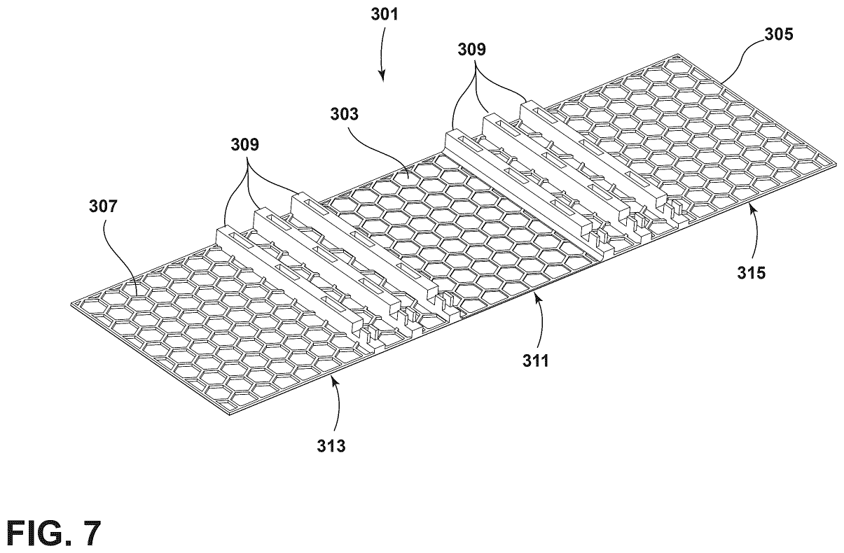

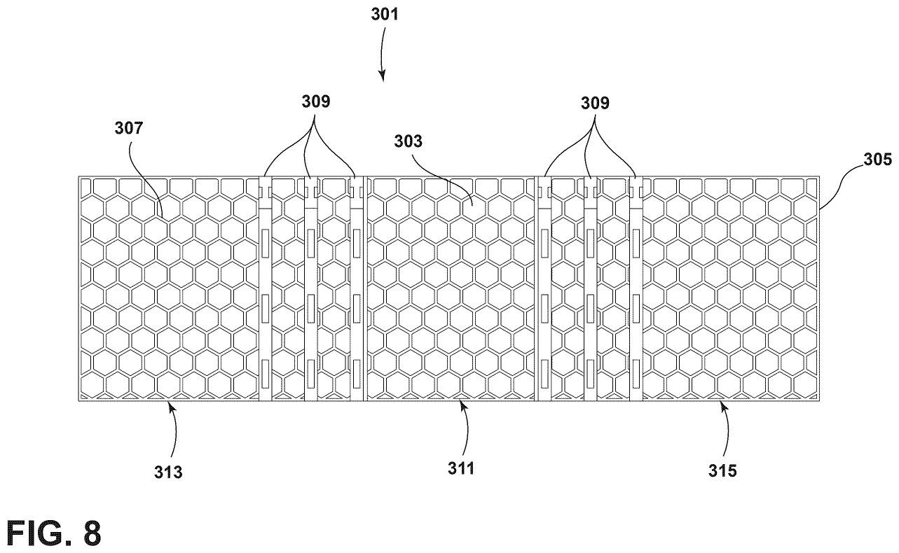

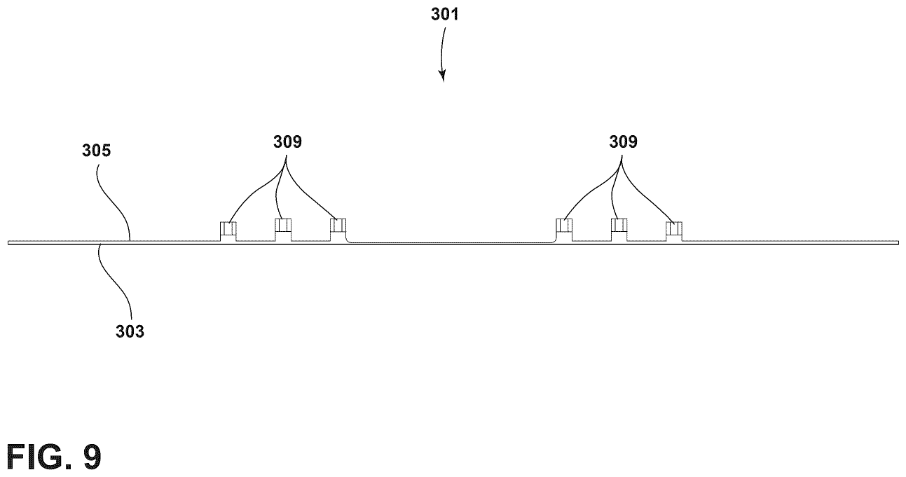

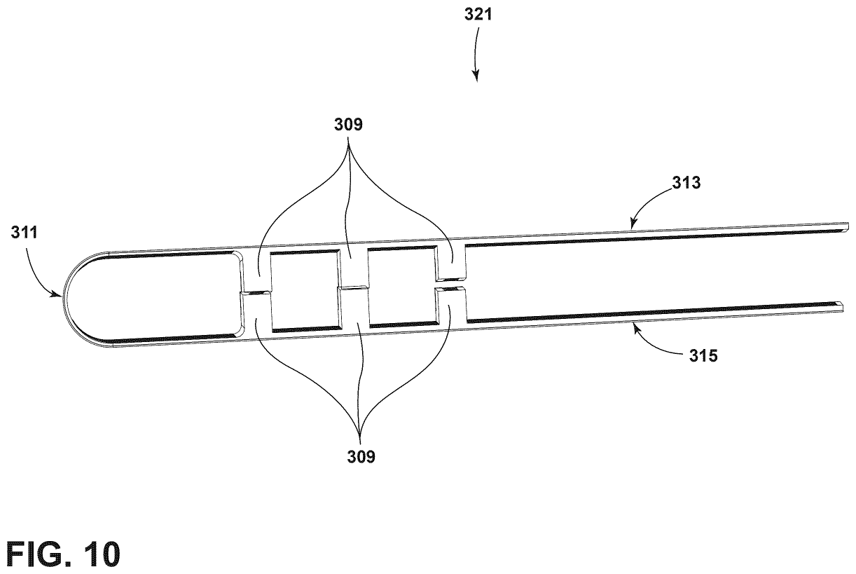

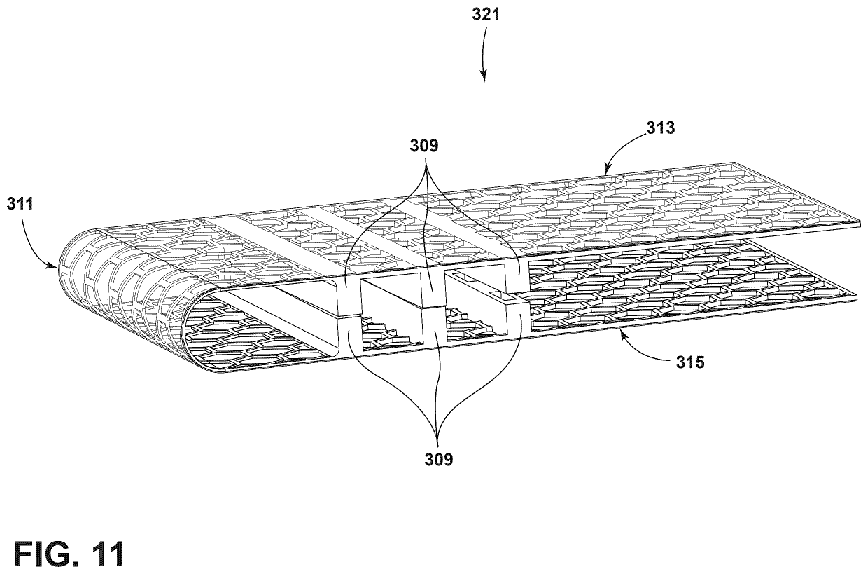

With reference to FIGS. 7-11, in Example 2 a desired part geometry is obtained by folding an additive build at a predetermined fold line, and fixing the additive build in the final shape having the desired part geometry with interlocking connector elements. As shown in FIGS. 7-9, the additive build 301 is printed as an unfolded, flattened shape and includes a substrate 303 and part-forming material 305. The substrate 303 is a fabric, sheet, or film that forms a flexible skin of the additive build 301. The part-forming material 305 is additively built into a lattice-like skeleton structure 307 as also interlocking connector elements 309. It should be understood that the material used as the part-forming material for the skeleton structure 307 may be the same as or different than material used as the part-forming material for the interlocking connector elements 309. A fold line 311 is predetermined in the additive build 301, but in this example the fold line 311 is simply a region in the additive build 301 and is not structurally different than the neighboring regions of the additive build, e.g. there are no tapered edges as in Example 1. The fold line 311 spatially divides the additive build 301 into a first portion 313 and a second portion 315. As shown in FIGS. 10 and 11, upon manipulation the portion 313 is folded over portion 315 thereby bending the additive build 301 along the fold line 311. In the folded configuration, the interlocking connector elements 309 of the first portion 313 align with and connect to the interlocking connector elements 309 of the second portion 315. The adjacent interlocking connector elements 309 may clip together, or alternatively and may be adhered to each other by and adhesive or other bonding material to fixt the portions 313, 315 in the folded configuration, thereby creating the desired final shape 321 from the flat additive build 301. It should be understood that the final shape 321 is merely illustrative, and a multitude of different shapes may be created in the same manner according to the method shown in Example 2.

Turning next to Example 3, a similar additive build structure such as that shown in Example 1 may be formed by depositing part-forming material onto a substrate. However, in Example 3 the substrate and/or the part-forming material includes a curable material such as but not limited to a urethane or epoxy resin. After deposition of the additive build, the additive build is manipulated into the desired final part shape (such as by bending the sides relative to the center similar to what is shown in FIGS. 5 and 6), and then the curable material in the substrate and/or part-forming material is fully cured to fix the part into the final shape. The curing may be accomplished by application of a stimulus such as UV radiation or heat, or by the passage of time, depending on whether, for example, the curable material is a UV-curable material, an ambient (heat)-curable material, or a latent-curable material. Thus, the fixing of the joints is accomplished by chemical bonding via curing. Further, optionally the substrate and/or part-forming material may be partially cured prior to manipulation into the final part shape, such as by application of an amount of UV radiation or heat that is only sufficient to partially cure the curable material, or in the case of a latent-curable material, by only allowing a certain amount of time to pass that is less than the amount of time necessary for full cure. Partial curing may be advantageous or necessary to provide the substrate and/or part-forming material with a degree of rigidity to be able to manipulate the additive build into the final shape without degradation of the structural integrity of the additive build caused by flow of uncured material.

Turning next to Example 4, a similar final part structure such as that shown in Example 1 may be formed by as shown in FIGS. 5 and 6. However, in Example 4, a plurality of the final part structures are formed, which may have the same geometry or different geometries. The plurality of part structures are then assembled together to obtain the completed desired part. For example, the completed desired part may be a boat, and the to convert the boat into a flattened, computer-modeled shape, the boat is divided into sections (e.g., a bow portion, a stern portion, and a central portion). Each section is then formed according to the method, such as in Example 1, and then these sections are joined, such as by adhesion or other form of bonding, to assemble the sections into the complete desired part.

Turning finally to Example 5, a similar additive build structure such as that shown in Example 1 may be formed by depositing part-forming material onto a substrate. However, in Example 5 the part-forming material is formed of a thermoplastic that has a higher HDT than a thermoplastic that forms the substrate. As such, to manipulate the additive build into the final part shape, the additive build is heated to a temperature at which the substrate softens while the structure formed by the part-forming material remains rigid. In this state, the additive build is manipulated into the desired final part shape, and then allowed to cool to allow the substrate material to reharden and fix the additive build in the final part shape.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of forming an additively manufactured part, the method comprising the steps of:
converting a desired final three-dimensional part geometry into a flattened, computer-modeled shape;
operating a printhead to deposit a first layer of a part-forming material on a substrate, the first layer being one of a plurality of iteratively deposited layers of an additive build according to the flattened, computer-modeled shape, such that the additive build is comprised of successive layers of the deposited part material on the substrate;
creating a part by manipulating one or more portions of the additive build at one or more predetermined locations to form the additive build into a final shape having the desired final three-dimensional part geometry, and fixing the additive build into the final shape.

2. The method of claim 1, wherein manipulating the additive build includes one or both of bending and folding the additive build at the one or more predetermined locations.

3. The method of claim 2, wherein the bending is performed along fold lines formed in the additive build.

4. The method of claim 3, further comprising the step of bonding or adhering adjacent portions of the additive build along the bent fold lines.

5. The method of claim 1, wherein the additive build includes a geometric locking element, and the method further comprises the step of interlocking the geometric locking element when manipulating the additive build in order to constrain the additive build in the final shape.

6. The method of claim 2, further comprising the step of curing the additive build after manipulating the additive build.

7. The method of claim 1, wherein the additive build includes one or more fold lines, and each fold line includes one or both of: i) tapered edges; and (ii) gaps between deposited part-forming material on the substrate.

8. The method of claim 1, wherein the additive build includes an articulated structure.

9. The method of claim 1, wherein the computer-modeled shape includes a planar lattice structure.

10. The method of claim 1, wherein the substrate is one of: i) a preformed material; and ii) formed by operating a printhead to deposit one or more layers of a substrate-forming material on a build surface.

11. The method of claim 1, wherein the substrate is also formed according to the flattened, computer-modeled shape.

12. The method of claim 1, wherein the substrate is flexible or includes both flexible and rigid portions.

13. The method of claim 1, wherein the substrate: i) is removed after manipulation of the additive build; ii) is integrated into the part created by manipulating the additive build; or iii) becomes the final part by removal of the additive build.

14. The method of claim 1, wherein the substrate comprises: i) a fabric; ii) a film; iii) a sheet; iv) a fabric laminated with a film; or v) a weave.

15. The method of claim 1, wherein the part-forming material is either: i) bondable to the substrate; ii) a curable material; or iii) both i) and ii).

16. The method of claim 1, wherein the part-forming material includes one or more of: i) a thermoplastic; ii) a thermoset; and iii) a plurality of different materials.

17. The method of claim 1, further comprising the step of operating a printhead to deposit a first layer of a scaffold material on one of the substrate or the additive build, the first layer being one of a plurality of iteratively deposited layers of a scaffold additive build according to a three-dimensional computer model of a scaffold, such that the scaffold additive build is comprised of successive layers of the deposited scaffold material that form the scaffold.

18. The method of claim 17, wherein the step of creating the part includes joining portions of the scaffold together.

19. The method of claim 17, wherein at least a portion of the scaffold is integrated into the part created by manipulating the additive build.

20. The method of claim 1, wherein the step of creating the part includes curing targeted portions of the additive build.

21. The method of claim 20, wherein the curing is performed by: i) application of an external stimulus; or ii) forming the targeted portions of the additive build with a plurality of part-forming materials having different cure rates.

22. The method of claim 1, wherein the part-forming material is a curable material, and the method further comprises the steps of:
partially curing the deposited part-forming material that forms the additive build;
while the part-forming material is only partially cured, manipulating the one or more portions of the additive build at the one or more predetermined locations in order to form the additive build into the final shape; and
subsequent to manipulating the additive build and while maintaining the additive build in the final shape, completing the curing of the part-forming material.

23. An additively manufactured part formed by the method of claim 1.
